(19) United States
(12) Patent Application Publication
(10) Pub. No.: US 2010/0070316 A1
(43) Pub. Date: Mar. 18, 2010

(54) METHODS AND SYSTEMS FOR MONITORING AND RECORDING CARBON FOOTPRINT DATA

(75) Inventors: Erez Lieberman, Cambridge, MA (US); Katharine E. Forth, Houston, TX (US); Ricardo Piedrahita, Boulder, CO (US); Qian Yang, Pembroke Pines, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: iShoe, Cambridge, MA (US)

(21) Appl. No.: 12/233,008

(22) Filed: Sep. 18, 2008

(51) Int. Cl. G06Q 10/00; G01C 21/00

(52) U.S. Cl. 705/7; 701/213

(57) ABSTRACT

This disclosure describes, generally, methods and systems for monitoring and reporting an entity's carbon footprint. The method may include gathering information about the entity. The information may include utility information. The method may further include equipping the entity with a global positioning system (GPS) device, an accelerometer, and a pressure sensor, and gathering utility usage data for the entity. Further, the method may include capturing travel data for the entity, and calculating the entity's carbon footprint based at least in part on the utility usage data and the travel data. Furthermore, the method may include generating a report of the entity's carbon footprint.

### CROSS-REFERENCE TO RELATED APPLICATIONS

This application is related to U.S. application Ser. No. ______ (Attorney Docket No. 027588-000100US), entitled METHODS AND SYSTEMS FOR SENSING EQUILIBRIUM, filed on ______, hereby expressly incorporated by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates, in general, to monitoring and reporting systems and methods, and more particularly, to monitoring and reporting carbon footprint data for an individual or group of individuals.

### BACKGROUND OF THE INVENTION

Presently, individuals and corporations determine their total carbon footprint in an ad hoc manner. Generally, the individual or corporation will attempt to make a rough estimate of their carbon emissions output. For example, an individual may count the number of flights they have taken, the number of times they commute to work per week, the type of food consumed, etc., and then roughly determine their carbon footprint. However, this method of determining a carbon footprint is not precise and only gives a person a general high level idea of their footprint.

Furthermore, once an individual or corporation has determined what is believed to be their carbon footprint, they must then make the effort to purchase carbon offsetting credits, and the like. This purchase is manual and can be sporadic and inconsistent. Accordingly, at present no precise and automated system exists which allows for monitoring, reporting, and offsetting carbon footprints. Hence, there is a need for improved methods and systems in the art.

### BRIEF SUMMARY OF THE INVENTION

Embodiments of the present invention include a method of monitoring and reporting an entity's carbon footprint. The method may include gathering information about the entity. The information may include utility information. The method may further include equipping the entity with a global positioning system (GPS) device, an accelerometer, and at least one pressure sensor and gathering utility usage data for the entity. Further, the method may include capturing travel data for the entity, and calculating the entity's carbon footprint based at least in part on the utility usage data and the travel data. Furthermore, the method may include generating a report of the entity's carbon footprint.

In a further embodiment, a system for monitoring and reporting an individual's carbon footprint is described. The system may include an article of clothing which includes an embedded global positioning system (GPS) device, an accelerometer, at least one pressure sensor, and a transmission module. The GPS device may be configured to capture travel data for the individual and the accelerometer may be configured to capture motion data for the individual. The transmission medium may be configured to transmit the travel and motion data.

The system may further include a data collection device connected with the transmission module. The data collection device may be configured to collect and store the transmitted travel and motion data. The system may further include a server connected with the data collection device. The server may be configured to calculate the individual's carbon footprint based at least in part on the travel data and the motion data and generate a report of the individual's carbon footprint.

In yet another embodiment, a machine-readable medium for monitoring and reporting an entity's carbon footprint is described. The machine-readable medium may include instructions for gathering information about the entity. The information may include utility information. The machine-readable medium may further include instructions for equipping the entity with a GPS device and an accelerometer, and gathering utility usage data for the entity. Further, the machine-readable medium may include instructions for capturing travel data for the entity, and calculating the entity's carbon footprint based at least in part on the utility usage data and the travel data. Furthermore, the machine-readable medium may include instructions for generating a report of the entity's carbon footprint.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a flow diagram illustrating a method for automatically monitoring and reporting carbon footprint data, according to one embodiment of the present invention.

FIG. 2 is a flow diagram illustrating a method for capturing travel data as it relates to carbon footprint data, according to one embodiment of the present invention.

FIG. 3 is a block diagram illustrating shoe insoles used to capture and report carbon footprint data, according to one embodiment of the present invention.

FIG. 4 is a block diagram illustrating components of a communications module, according to one embodiment of the present invention.

FIG. 5 is a block diagram illustrating footwear used in conjunction with the insoles, according to one embodiment of the present invention.

FIG. 6 is a block diagram illustrating a system for monitoring and reporting carbon footprint data, according to one embodiment of the present invention.

FIG. 7 is a generalized schematic diagram illustrating a computer system, in accordance with various embodiments of the invention.

FIG. 8 is a block diagram illustrating a networked system of computers, which can be used in accordance with various embodiments of the invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

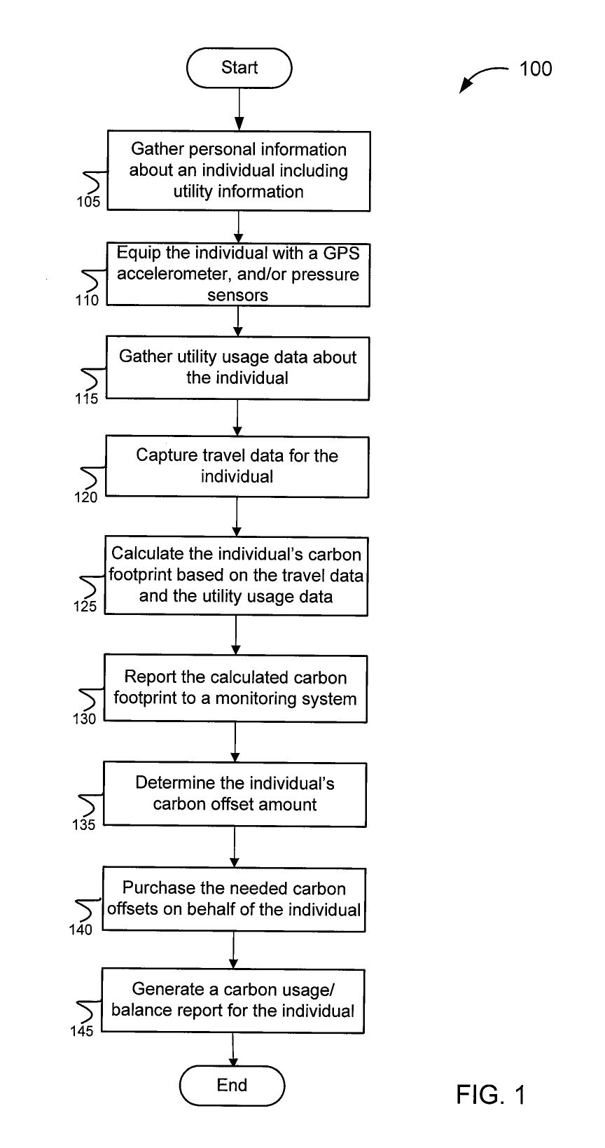

According to one embodiment of the present invention, FIG. 1 illustrates a method 100 of monitoring and reporting carbon footprint data. At process block 105, personal information may be gathered about an entity. In one embodiment, an entity may be an individual, a family, a corporation, an organization, etc. For the purposes of ease of understanding and explanation, reference will be made to an individual. However, it should be noted that the individual can be replaced with a family, a corporation, an organization, etc.

The personal information gathered about the individual may include utility information, housing information, vehicle information, career information, travel habits, dinning habits, and so forth. The utility information may include electric bill information, gas bill information, heating bill information, air conditioning bill information, water bill information, etc. The carbon footprint monitoring and reporting system may be granted access to account information for utilities, such that the system is able to be kept up-to-date on current utility consumption for the individual.

Housing information may include the number of houses owned/used by the individual including the specifications of the houses. For example, the square footage of the house, the date in which the house was built, the efficiency rating of the house (i.e., the type of insulation, exterior material, etc.), etc. Furthermore, the cooling and/or heating system installed in the house (e.g., central heating and air, swamp cooler, attic fan, etc.) may be included in the housing information. In addition, the average amount of time the individual spends at the house (i.e., is it a summer home, a vacation home, primary residence, a rental property, etc.) may also be included.

In addition, the individual may provide the monitoring system with the house's address, which may be used to glean information about the house. For example, by entering the address into a real estate website (i.e., www.zillow.com, or the like) detailed information about the house may be determined. Such information may include the year the house was built, the house's square footage, the construction materials used on the house, etc. Alternatively, the individual may provide the monitoring system with a link to their house's zillow site.

Furthermore, vehicle information may include the number of vehicles owned/used by the individual, as well as the type of the vehicle (e.g., automobile, plane, boat, etc.). In addition, the make and model of an automobile including whether it is a hybrid, flex-fuel, etc. may be provided. Further, the average gas mileage of the vehicle, as well as the type of driving (e.g., city, highway, off-road, extreme, etc.) may be provided. Additionally, the primary use of the vehicle may be provided.

Career information and travel habits may include how often the individual travel for work, how far is their commute, how often do they telecommute, etc. Travel habits may include how often the individual flies in an airplane, how often the individual travels for pleasure or for work, etc. Furthermore, dinning habits may include how often the individual dines-in or dines-out, how close the dining establishments are in proximity to their home or work, etc. It should be noted that such information as described above may be useful in helping to determine an individual's carbon footprint; the information still may only provide part of the individual's carbon footprint. As such, in order to provide a more complete calculation of the individual's carbon footprint, additional information may be gathered, as shown in the method steps below.

At process block 110, the individual may be equipped with a GPS device, an accelerometer, and/or one or more pressure sensors. In one embodiment, the GPS device and the accelerometer may be embedded in the individual's clothing (e.g., a pair of shoes, a shirt, a jacket, a pair of pants, etc.). Alternatively, the GPS device and/or the accelerometer may be embedded in a watch or watch-like device which may be worn on the individual's wrist, ankle, etc. Essentially, the GPS device and the accelerometer may be configured to gather position data and motion data for the individual, which may then be used to further determine the individual's carbon footprint.

At process block 115, utility usage data may be gathered about the individual. For example, the total number of kilowatt hours of power used, the total amount of natural gas used, and the total number of gallons of water consumed may be gathered. In addition, the total number of gallons of gasoline may also be gathered. Hence, a complete picture of utility resources consumed by the individual may be gathered.

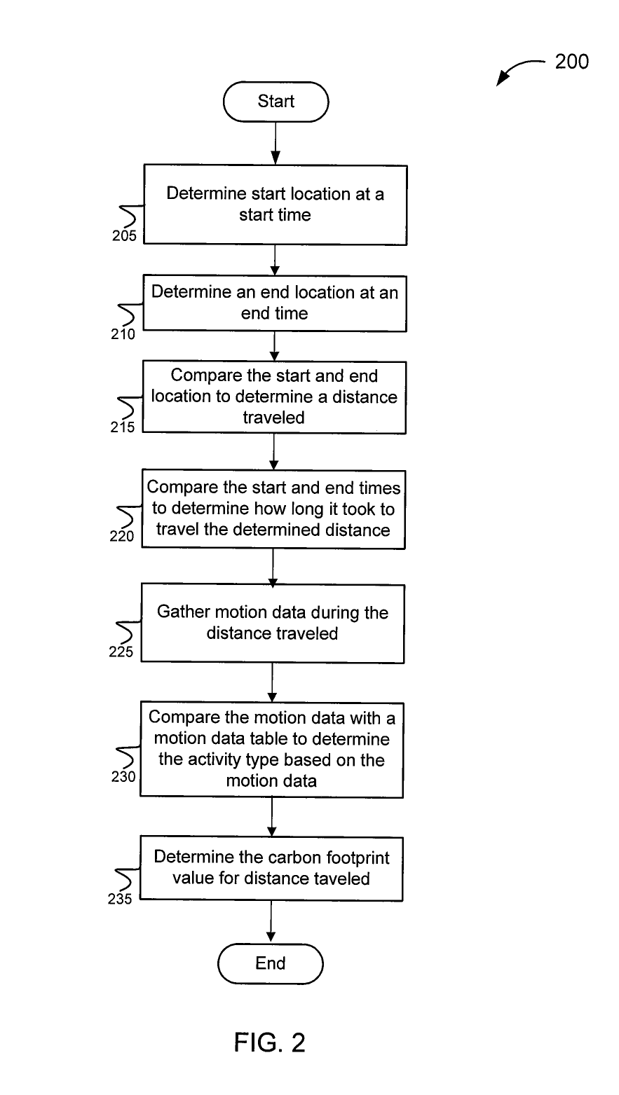

Furthermore, travel data for the individual may be captured (process block 120). The method of capturing such travel data is further explained in FIG. 2 described below. Nonetheless, at a high level collection of travel data may include calculating where the individual has traveled, and what mode of transportation was used for travel. For example, if the GPS device indicates that the individual was in Los Angeles at 10 am, and then in New York only five hours later, it can be determined that the individual has traveled on an airplane across the United States. Alternatively, if the individual was in Boston, Mass. at 2 pm, and then thirty-five minutes later the individual is in Quincy, Mass., then it can be determined that the individual has traveled in an automobile.

Furthermore, the accelerometer may be used to determine motion data regarding the individual's travel activities. For example, the right foot of an individual driving an automobile differs greatly from an individual which is a passenger in the automobile. In addition, an individual walking differs from an individual riding a bicycle. Hence, the accelerometer may be used to determine the type of travel activity the individual is taking part in based on gathered motion data. Additionally, the gathered motion data may be compared with a motion table which includes motion signatures which may be used to identify certain activities based on the gathered motion data. In addition, the pressure sensor(s) may be used to determine the postural state of the individual, which can indicate the type of travel activity the individual is taking part in (e.g., riding, biking, sitting, driving, etc.).

At process block 125, based on the gathered utility usage information as well as the travel information captured for the individual, the individual's carbon footprint is calculated. One skilled in the art can appreciate that a variety of algorithms and calculations may be used in order to determine the individual's carbon footprint. For example, a table which includes a footprint value for each type of travel activity/utility usage based on the amount of travel/usage may be used. Nonetheless, once the carbon footprint has been calculated a report of the individual's carbon footprint may be generated and reported to a monitoring system (process block 130). In one embodiment, the report may include detailed information outlining each carbon contribution factor, the amount the factor has contributed to the individual's footprint, etc. Furthermore, the report may be viewed by the individual in a browser or other display program on a personal computer, a portable computing device, etc.

At process block 130, the carbon offset needed for the individual may be determined. For example, an offset table or database may be accessed which details an offset cost based on the carbon footprint of the individual. For example, if the footprint is between 100 and 110 in a month, then the offset is $2000.00, if the footprint is between 150 and 160, then the offset is $2500.00, and so forth. Ultimately, one skilled in the art would appreciate that a variety of offset calculations may be made in order to determine the individual's total cost.

Once the needed offset amount is determined, the offset may be purchased on behalf of the individual (process block 140). In one embodiment, the individual may be able to select an offset organization to use, or alternatively, an offset organization may be chosen on their behalf. In addition, the individual may establish an automatic withdrawal with the offset organization such that, on a set schedule (e.g., monthly, quarterly, yearly, etc.), the offset organization can deduct the offset amount based on the individual's accumulated carbon footprint. Accordingly, the individual can automatically maintain a zero carbon footprint status.

At process block 145, a carbon usage/balance report may be generated for the individual. Such a report may include a line by line detailed report of all carbon emitting activities and the carbon footprint cost associated with the activities. Furthermore, the report may include the total footprint and the amount of the offset(s) paid in order to balance out the individual's carbon footprint.

Turning now to FIG. 2, which illustrates a method 200 of calculating travel data, in accordance with embodiments of the present invention. As discussed above, travel activities may be considered a significant part of determining an individual's carbon footprint. As such, method 200 describes a method for calculating travel data in accordance with embodiments of the present invention. At process block 205, a determination may be made of an individual's start location at a start time. For example, the individual may be at Denver International Airport (DIA) at 2 pm (MST). However, the start location could be anywhere, for example, the individual's home location, their work location, etc.

Furthermore, at process block 210, a determination is made regarding the individual's end location and end time. For example, the end location may be Dulles International Airport (IAD) at 8 pm (EST) (i.e., 4 hours have passed between the time the individual was at DIA and is now at IAD). At process block 215, the start location and end location may be compared to determine the distance traveled (in this example 1,662 miles). Furthermore, at process block 220, the start time and the end time may be compared to determine the amount of time it took to travel the determined distance.

Therefore, based on the fact that the individual traveled 1,662 miles in only 4 hours, it is determined that the individual was traveling in an airplane. In one embodiment, a partnership with an airline(s) may be established which provides the monitoring system with access to gate information, aircraft specifications (e.g., fuel usage, passenger capacity, etc.), departure times, arrival times, etc. Thus, the monitoring system can cross reference the individual's travel locations, distances, and times and determine the flight that the individual was on, and hence know how much fuel was used and ultimately the precise carbon footprint value of the flight. Alternatively, the individual can either provide the monitoring system with access to their flight itinerary information or the individual may report their flight activities. In addition, the individual may provide the monitoring system with airline frequent flyer account access/information. Such access and/or information may further be used to determine the individual's flights taken, and ultimately the carbon footprint value associated with those flights. Either way, the monitoring system is able to determine the precise carbon footprint for any flight in which the individual is a passenger. Additionally, this process may be repeated for any additional flights, as well as for other types of travel.

For example, the individual may have traveled 30 miles in 30 minutes, which would indicate that the individual traveled that distance by car. The average speed may be determined to be 55 miles per hour, which would indicate that the car was traveling on the highway. Based on the provided vehicle information (alternatively, the vehicle may be remotely accessed to determine the vehicle information), the amount of gasoline (or other fuel depending on the car fuel type) used to make that trip is determined. Additionally, access to gas card loyalty and/or credit accounts may be given to the monitoring system. As such, the monitoring system may determine the exact amount of gasoline purchased and ultimately consumed by the individual, and thus determine the carbon footprint value associated with the consumption. Thus, the carbon footprint value for the trip can also be determined.

Furthermore, at the individual travels a Bluetooth device (or similar wireless device) may be used to collect “census data” about the individual's surroundings. For example, nearby devices may be detected which could indicate whether the individual is on a bus, in an airport, in a restaurant, in a taxi cab, etc. In addition, information regarding the number of cell phones or other electronic devices surrounding the individual collected by the wireless device may be used to determine if the individual, for example, is alone in a car or if the car has other passengers. Such information could be used to determine if the individual is carpooling, on a bus, an airplane, etc.

The carbon footprint accrued by the individual may vary based on whether the individual is the driver of the car or a passenger in the car. In addition, the individual may be riding a bicycle at a sufficiently fast speed which may make it appear that the individual is traveling in a car. Accordingly, motion data may be needed to accurately determine the travel activity of the individual. At process block 225, motion data may be gathered about the individual using, for example, an accelerometer.

For example, the motion data collected when the individual is walking is much different from the motion data collected when the individual is riding a bicycle, which is in turn is much different from when the individual is riding in a car. Furthermore, the motion data of, for example, the individual's right foot when driving a car is much different from the motion data when the individual is simply a passenger in the car (process block 230). Therefore, the motion data in conjunction with the travel data can precisely determine the travel activity of the individual, and thus determine the carbon footprint value of the travel activity (process block 235).

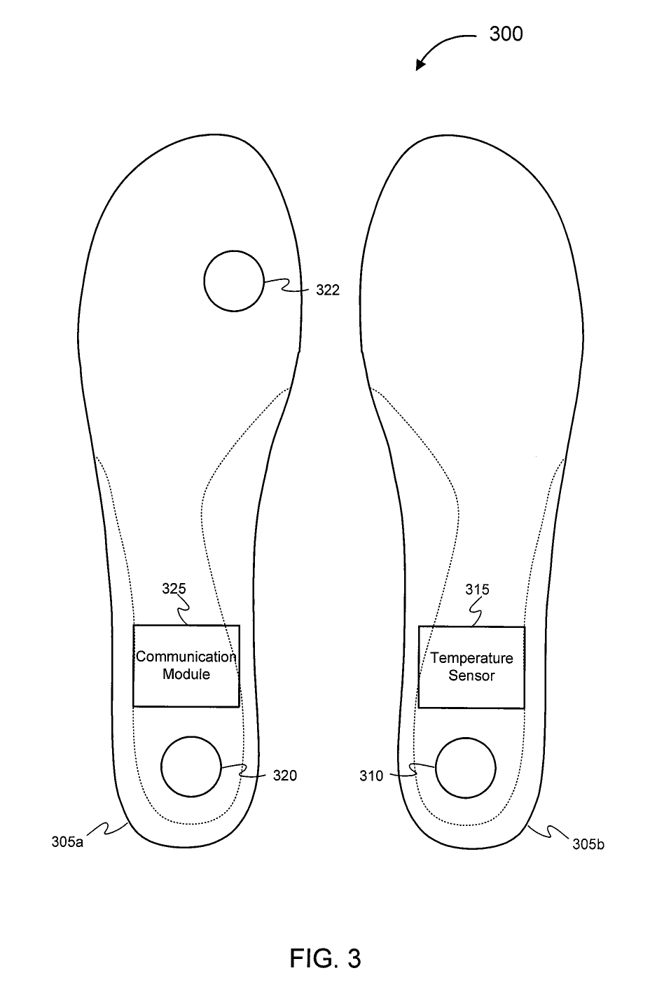

Referring now to FIG. 3, which illustrates insoles 300 which may be used in conjunction with aspects of the present invention. In one embodiment, insoles 300 may include a right insole 305a and a left insole 305b. Insoles 305a and 305b may be inserted into any type of footwear (e.g., tennis shoes, boots, ski boots, medical footwear, etc.). Furthermore, insoles 305a and 305b may be any size, shape, etc. suitable for use in footwear.

In a further embodiment, insole 305b may include a GPS device 310. It should be noted generally, that the placement of the GPS device 310 and other elements in FIG. 3 does not have any special significance, and that elements may be moved to any other location, and additionally may be resized, accordingly. Furthermore, elements housed in insoles 300 may be enclosed/protected in a suitable protective material. GPS device 310 is configured to be used according to methods 100 and 200 (FIGS. 1 and 2) described above. GPS device 310 may gather location information for the individual wearing insoles 305a and 305b, in order to facilitate determining the individual's carbon footprint. In a further embodiment, insole 305b may include a temperature sensor 315. Temperature sensor 315 may be configured to make temperature readings and use such temperature reading in further determining the individual's carbon footprint. Furthermore, GPS device 310 may be used to determine the square footage of the individual's house. For example, as the individual moves about their house, GPS device 310 can capture locations throughout the house, and from that location information the square footage of the house can be ascertained.

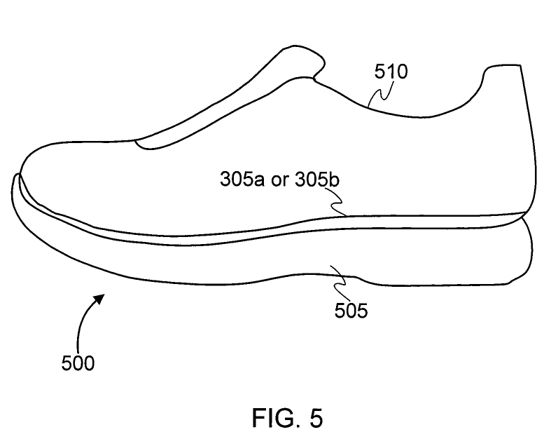

Insole 305a may include an accelerometer 320 which is configured to gather motion data about the individual as described above in methods 100 and 200 (FIGS. 1 and 2). Further, insole 305a may also include a communications module 325. Communications module 325 may communicate, for example, wirelessly, via Bluetooth, USB, FireWire, via cellular, etc. Communications module 325 may be configured to communication positioning, motion, and temperature data to an external source (which will be described in more detail in FIG. 5 below).

Insole 305a may further include a pressure sensing device 322. Pressure sensing device 322 may be used to determine postural state information. In one embodiment pressure sensing device 322 is a piezoelectric force sensor. Furthermore, additional pressure sensing devices may be additionally embedded into insole 305a or 305b. In addition, a Hidden Markov Model (HMM) calculation may be used to determine the current and/or next postural state based on pressure data collected from pressure sensing device 322. The HMM calculation utilizes a set of probabilities for each postural state to determine the next postural state. In some examples, a determination of the next, current, and/or past postural states may utilizes a posterior decoding algorithm, a Bayesian segmentation, a graphical model, a choice-point method, and/or any other type of algorithm that classifies time periods into static and/or dynamic periods. A dynamic Bayesian network can be, for example, utilized to determine the next and/or past postural states based on the current postural state.

In other examples, the determination of the next, current, and/or past postural states utilizes a forward algorithm, a Viterbi algorithm, a forwards-backwards algorithm, Baum-Welch algorithm, and/or any other type of algorithm that classifies time periods into static and/or dynamic periods. The forwards-backwards algorithm or Viterbi algorithm can be, for example, utilized to determine the probability of the next state (e.g., dynamic, equilibrium). The Baum-Welch algorithm can be, for example, utilized to determine the range of postural stability and/or the probabilities of transitioning between states. In some examples, the HMM calculation determines the next state, the current state, and/or one or more past states (e.g., five, ten). The HMM calculation can be, for example, utilized to determine the probabilities of the sequence of the past states, the current state, and/or the next state. The sequence of the past states can be, for example, utilized to calculate the probability of the next state.

In one embodiment, the pressure data collected from pressure sensor 322 may be used to determine the individual's postural state (or states), which may further be used in conjunction with accelerometer 320 to determine the travel activity that the individual is engaged in. Accordingly, based at least in part on the individual's postural state as well as their accompanying motion, the individual's type of travel is determined. It should be noted that any of GPS device 310, accelerometer 320, or pressure sensor 322 may be removed from insoles 305a and 305b and placed in any article of clothing or on any place on the individual's person.

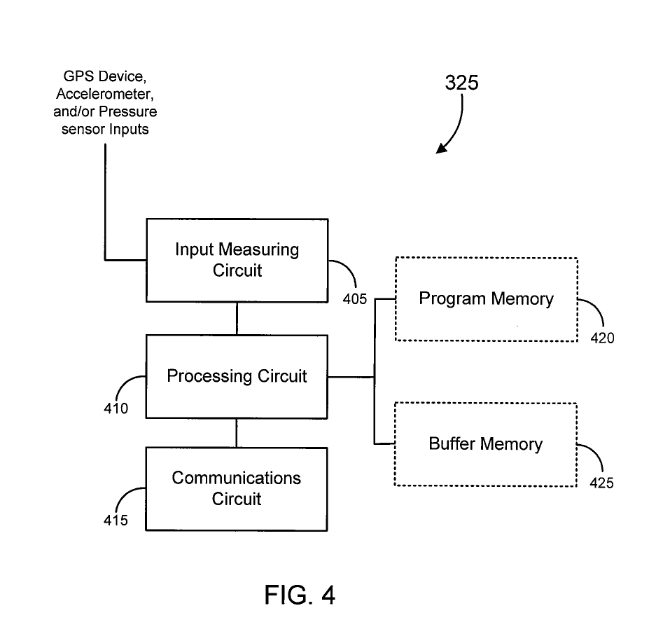

FIG. 4 shows a simplified block diagram of one embodiment of communications module 325. As illustrated, communications module 325 may include one or more input measuring circuits 405, a processing circuit 410, and a communications circuit 415. Communications module 325 also may optionally include a program memory 420 and/or a buffer memory 425. It will be appreciated that communications module 325 may comprise one or more integrated circuits (e.g. microcontroller, etc.), and/or discrete components on a printed circuit board, a flexible printed circuit board, or other electronic packaging technology. A power source such as a battery may be attached by any suitable arrangement for providing power to the circuits of the communications module 325 may also be included. In addition, energy harvesting may be used as an alternative energy source.

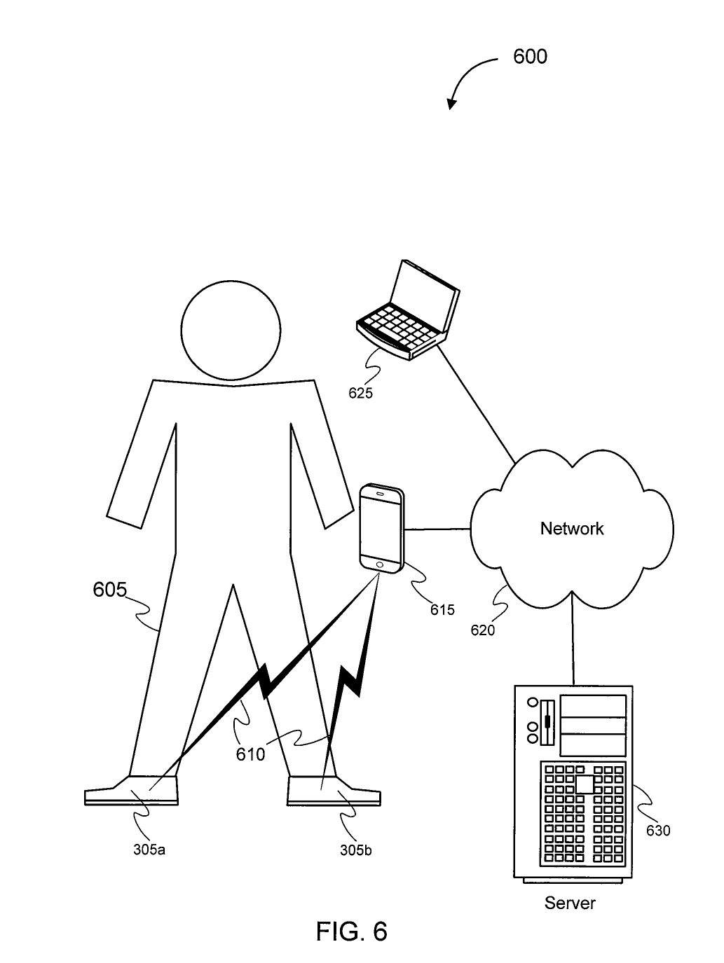

In the exemplary embodiment described above, input measuring circuit 405 samples the output of GPS device 310, pressure sensor 322, and/or accelerometer 320 (as shown in FIG. 3) to produce digital data values. Input measuring circuit 405 may have an internal timing circuit to determine the sampling frequency, or alternately the sampling frequency may be determined by processing device 410. Processing circuit 410 receives the digital data values from the input measuring circuit 405, can write and read data values to/from buffer memory 425, and transfer data values to communications circuit 415. Processing circuit 410 may write the data values to buffer memory 425 for a predetermined period of time, or until buffer memory 425 has received a certain quantity of data values, at which time processing circuit 410 may read a quantity of data values from buffer memory 425 and transfer the quantity of data values to communications circuit 415. Communications circuit 415 may receive the data values from processing device 410 and transmit the data values over communications link 610 (FIG. 6) to data collection device 615 (FIG. 6). For example, buffer memory 425 may be a 256 MB memory, and processing circuit 410 may write the data values to buffer memory 430 until buffer memory 425 is at full capacity or close to full capacity (e.g. 90% capacity, 95% capacity, etc.), at which time processing circuit 410 reads the data values previously written to buffer memory 425 and transfers the data values to communications circuit 415 to be transmitted over communications link 610 (FIG. 6) to data collection device 615 (FIG. 6). It will be appreciated that design considerations such as buffer memory size, power consumption, system cost, and/or communications link parameters may be considered in determining data values stored and/or the period of time that data values are stored in buffer memory 425 before the transmission of a quantity of data values by communications circuit 415.

Input measuring circuit 405 may contain analog to digital converters (ADCs), timers, and other discrete or integrated components used to convert the analog output of GPS device 310, pressure sensor 322, and/or accelerometer 320 (as shown in FIG. 3) to digital data values. Processing circuit 410 can comprise any general purpose processor, a microprocessor, and/or other suitably configured discrete or integrated circuit elements. Program memory 420 may be any type of non-volatile storage medium including solid-state devices such as EPROM, EEPROM, FLASH, MRAM, or similar components for data storage. Buffer memory 425 may be any type of volatile or non-volatile storage element including solid-state devices such as DRAM, SRAM, FLASH, MRAM, or similar components for data storage. Communications circuit 415 may transmit and receive data over any type of communications link, for example, communications circuit 415 may comprise a wireless transceiver utilizing an RF network such as a Bluetooth network. Communications circuit 415 may include authentication capability to limit transfer of data from insoles of one person to only authorized devices. Additionally, communications circuit 415 may encrypt data before transmission in order to prevent unauthorized access of the information.

Turning now to FIG. 5, which illustrates footwear 500 which may utilize insoles 300 (FIG. 3). Footwear 500 may include a sole 505, which may optionally house various elements found housed in insoles 300 (FIG. 3) (i.e., GPS device 310, accelerometer 320, pressure sensor 322, temperature sensor 315, or communications module 325 (as shown in FIG. 3)). Footwear 500 may also include an upper portion 510 for fitting the individual's foot. Furthermore, footwear 500 may be configured to allow for insole 305a or 305b to be placed on top of sole 505.

In a further embodiment, a shoe company may partner with the monitoring system and have a special “green” shoe which implements the carbon footprint monitoring and reporting system according to aspects of the present invention. The shoe may be a special color or have a special logo indicating that the shoe is part of a green friendly campaign, etc. The shoe company may offer the shoe at a free or reduced price in exchange for the publicity, advertising, and goodwill obtained for being a part in the program.

Referring next to FIG. 6, which illustrates a system 600 for implementing a carbon footprint monitoring and reporting system according to embodiments of the present invention. System 600 may include insoles 305a and 305b which gather location and motion data as described above in FIG. 3. Nonetheless, individual 605 may alternatively wear the sensors included in insoles 305a and 305b on a watch or similar device, or they may be embedded in an article of clothing. Ultimately, individual 605 is to have a GPS device, a pressure sensor, and/or an accelerometer on their person in order to gather and transmit location and/or motion data.

System 600 may further include connections link 610 which are configured to transmit the location and motion data to a data collection device 615. In one embodiment, connections link 610 may be wired connections, wireless connections, Bluetooth connections, cellular connections, etc. Furthermore, data collection device 615 may be a handheld computer, a mobile computing device, a cellular device, an iPhone™ (or equivalent device), an iPod™ (or equivalent device), etc. Data collection device 615 may be configured to collect and store the data received regarding the location and the motion of individual 605.

Further, system 600 may include a network 620 in which data collection device 615 may be connected. Data collection device 615 may be connected to network 620 by being cradled, connected via a network port, or any other suitable connection type. Network 620 may then be connected to personal computer 625 and/or server 630. Alternatively, data collection device 615 may be directly connected to personal computer 625 and/or server 630. Furthermore, the data collected by data collection device 615 may be continuously monitored by server 630 and uploaded to server 630.

In a further embodiment, once server 630 receives the collected data, server 630 may be configured to calculate the carbon footprint values based on the travel activities determined by the data received. Hence, once server 630 has calculated individual 605's carbon footprint, server 630 can purchase the offsets for individual 605, as well as generate a report for viewing by individual 605 on, for example, a web browser executed on personal computer 625. Accordingly, system 600 is configured to implement the carbon footprint monitoring and reporting system described in detail above.

In an alternative embodiment, data collection device 615 may be a cellular phone (or similar personal digital assistant (PDA)) with Internet capabilities. Accordingly, data may be transferred from communications link 610 to the cellular phone using Bluetooth (or the like). Once the cellular phone receives the data the cellular phone I then configured to transmit the received data to server 630 via the cellular phone's Internet connection. Hence, travel, motion, and postural data may be transmitted to server 630 from any location with Internet connectivity. Furthermore, individual 605's carbon footprint data may be continuously updated at server 630.

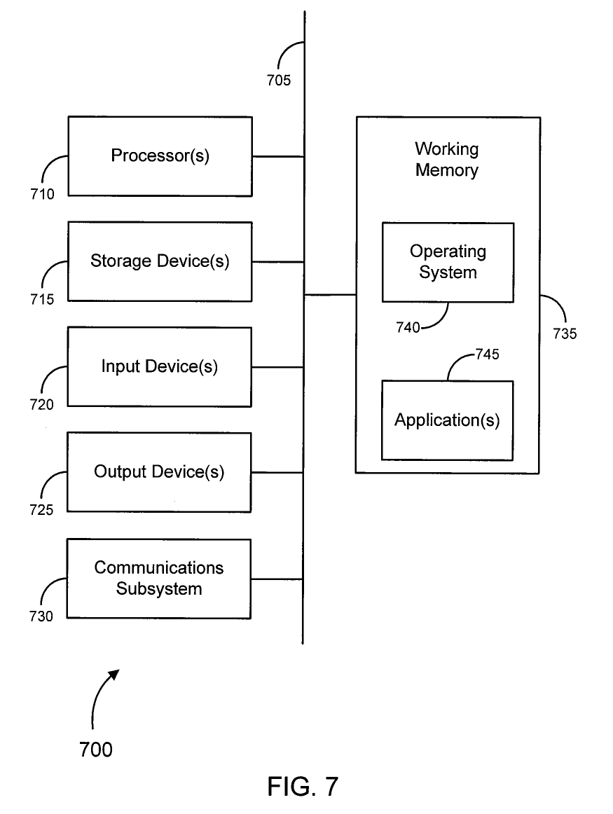

FIG. 7 provides a schematic illustration of one embodiment of a computer system 700 that can perform the methods of the invention, as described herein, and/or can function, for example, as any part of data collection device 615 (FIG. 6) or personal computer 625 (FIG. 6). It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements can include one or more processors 710, including without limitation one or more general-purpose processors and/or one or more special-purpose processors (such as digital signal processing chips, graphics acceleration chips, and/or the like); one or more input devices 715, which can include without limitation a mouse, a keyboard and/or the like; and one or more output devices 720, which can include without limitation a display device, a printer and/or the like.

The computer system 700 may further include (and/or be in communication with) one or more storage devices 725, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 700 might also include a communications subsystem 730, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 730 may permit data to be exchanged with a network (such as the network described below, to name one example), and/or any other devices described herein. In many embodiments, the computer system 700 will further comprise a working memory 735, which can include a RAM or ROM device, as described above.

The computer system 700 also can comprise software elements, shown as being currently located within the working memory 735, including an operating system 740 and/or other code, such as one or more application programs 745, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 700) to perform methods of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another machine-readable medium, such as one or more of the storage device(s) 725. Merely by way of example, execution of the sequences of instructions contained in the working memory 735 might cause the processor(s) 710 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 700, various machine-readable media might be involved in providing instructions/code to processor(s) 710 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 725. Volatile media includes, without limitation dynamic memory, such as the working memory 735. Transmission media includes coaxial cables, copper wire and fiber optics, including the wires that comprise the bus 705, as well as the various components of the communication subsystem 730 (and/or the media by which the communications subsystem 730 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc., carried by the signals) to the working memory 735, from which the processor(s) 705 retrieves and executes the instructions. The instructions received by the working memory 735 may optionally be stored on a storage device 725 either before or after execution by the processor(s) 710.

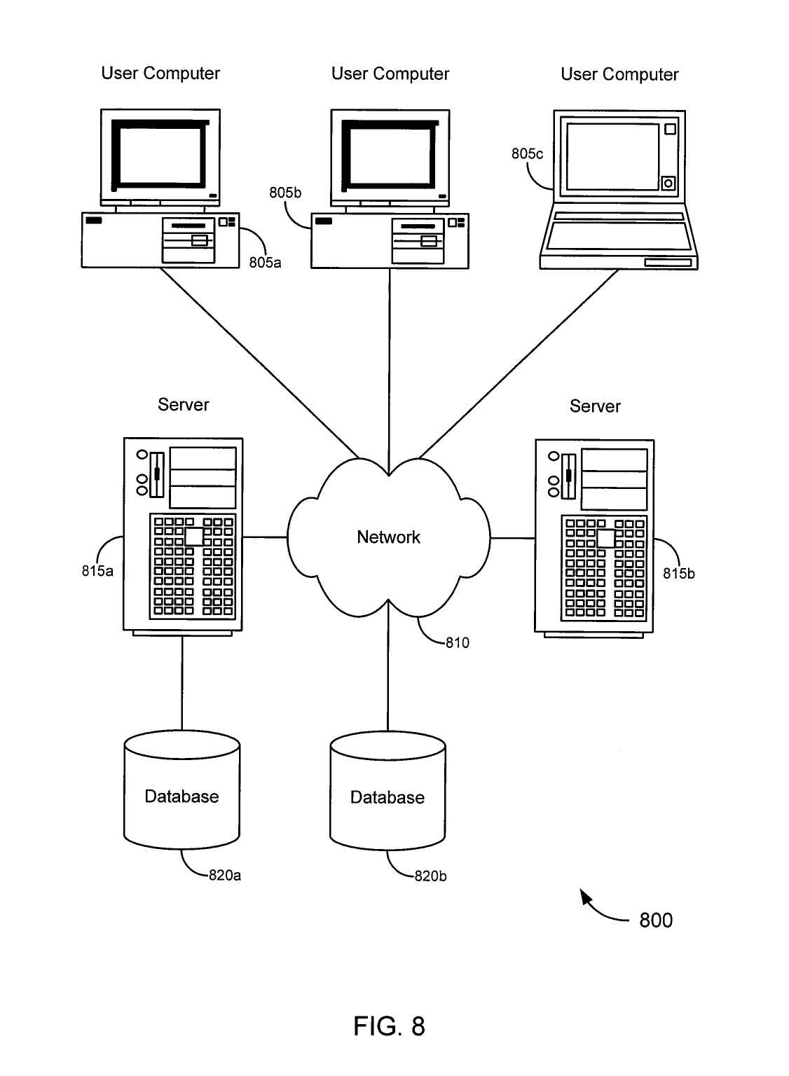

A set of embodiments comprises systems for implementing staged configurator modeling. In one embodiment, user computers 705 and/or servers 715 may be implemented as computer system 700 in FIG. 7. Merely by way of example, FIG. 8 illustrates a schematic diagram of a system 800 that can be used in accordance with one set of embodiments. The system 800 can include one or more user computers 805. The user computers 805 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 805 can also have any of a variety of applications, including one or more applications configured to perform methods of the invention, as well as one or more office applications, database client and/or server applications, and web browser applications. Alternatively, the user computers 805 can be any other electronic device, such as a thin-client computer, Internet-enabled mobile telephone, and/or personal digital assistant (PDA), capable of communicating via a network (e.g., the network 810 described below) and/or displaying and navigating web pages or other types of electronic documents. Although the exemplary system 800 is shown with three user computers 805, any number of user computers can be supported.

Certain embodiments of the invention operate in a networked environment, which can include a network 810. The network 810 can be any type of network familiar to those skilled in the art that can support data communications using any of a variety of commercially-available protocols, including without limitation TCP/IP, SNA, IPX, AppleTalk, and the like. Merely by way of example, the network 810 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 815. Each of the server computers 815 may be configured with an operating system, including without limitation any of those discussed above, as well as any commercially (or freely) available server operating systems. Each of the servers 815 may also be running one or more applications, which can be configured to provide services to one or more clients 805 and/or other servers 815.

Merely by way of example, one of the servers 815 may be a web server, which can be used, merely by way of example, to process requests for web pages or other electronic documents from user computers 805. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 805 to perform methods of the invention.

The server computers 815, in some embodiments, might include one or more application servers, which can include one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configurator, database clients, API clients, web browsers, etc.) running on a user computer 805 and/or another server 815. In some embodiments, an application server can create web pages dynamically for displaying the information in accordance with embodiments of the invention, such as web pages displayed by personal computer 625 (FIG. 6). Data provided by an application server may be formatted as web pages (comprising HTML, Javascript, etc., for example) and/or may be forwarded to a user computer 805 via a web server (as described above, for example). Similarly, a web server might receive web page requests and/or input data from a user computer 805 and/or forward the web page requests and/or input data to an application server. In some cases a web server may be integrated with an application server.

In accordance with further embodiments, one or more servers 815 can function as a file server and/or can include one or more of the files (e.g., application code, data files, etc.) necessary to implement methods of the invention incorporated by an application running on a user computer 805 and/or another server 815. Alternatively, as those skilled in the art will appreciate, a file server can include all necessary files, allowing such an application to be invoked remotely by a user computer 805 and/or server 815. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 820. The location of the database(s) 820 is discretionary: merely by way of example, a database 820a might reside on a storage medium local to (and/or resident in) a server 815a (and/or a user computer 805). Alternatively, a database 820b can be remote from any or all of the computers 805, 815, so long as the database can be in communication (e.g., via the network 810) with one or more of these. In a particular set of embodiments, a database 820 can reside in a storage-area network (“SAN”) familiar to those skilled in the art. (Likewise, any necessary files for performing the functions attributed to the computers 805, 815 can be stored locally on the respective computer and/or remotely, as appropriate.) In one set of embodiments, the database 820 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware, and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of monitoring and reporting an entity's carbon footprint, the method comprising:
gathering information about the entity, wherein the information includes utility information;
equipping the entity with a global positioning system (GPS) device, an accelerometer, and at least one pressure sensor;
gathering utility usage data for the entity;
capturing travel data for the entity;
calculating the entity's carbon footprint based at least in part on the utility usage data and the travel data; and
generating a report of the entity's carbon footprint.

2. The method of claim 1, wherein the entity is one or more of the following: an individual, a corporation, and an organization.

3. The method of claim 1, wherein the calculating of the entity's carbon footprint further comprises:
determining a first location at a first time of the entity based on the GPS device location information;
determining a second location at a second time of the entity based on the GPS device location information;
comparing the first and second locations to determine a distance traveled; and
comparing the first time and the second time to determine an amount of time for the entity to travel the distance.

4. The method of claim 3, wherein the calculating of the carbon footprint further comprises:
gathering motion data of the entity from the accelerometer and the at least one pressure sensor for the distance traveled; and
comparing the motion data against a motion data table, wherein the motion data table includes motion data readings for a plurality of activities.

5. The method of claim 4, wherein the plurality of activities include one or more of the following activity types: walking, jogging, cycling, driving, riding in an automobile, and riding in a plane.

6. The method of claim 5, further comprising:
determining an activity type based on the comparison of the motion data against the motion data table; and
determining a carbon footprint value for the activity type in conjunction with the distance traveled.

7. The method of claim 6, wherein the calculating of the carbon footprint further comprises repeating determining a carbon footprint value for each travel activity made by the entity.

8. The method of claim 1, wherein the GPS device, the accelerometer, and the at least one pressure sensor are embedded in an article of clothing.

9. The method of claim 8, wherein the article of clothing includes one or more of the following: a shoe, a shoe insole, a jacket, a shirt, pants, and a watch.

10. The method of claim 2, wherein the information about the entity includes one or more of the following: residence size, types of utilities, distance from the residence to an employment location, travel habits, make of primary vehicle, model of the primary vehicle, the individual's height, and the individual's weight.

11. The method of claim 10, wherein the types of utilities include one or more of the following: gas, electric, heating, and cooling.

12. The method of claim 1, further comprising automatically purchasing carbon offsets to balance the entity's carbon footprint.

13. The method of claim 12, further comprising displaying in the report the entity's carbon footprint versus the entity's carbon offsets balance.

14. The method of claim 1, wherein the travel data includes one or more of the following: gate information, airplane specifications, fuel requirements for the airplane, and distance of a flight associated with the gate.

15. A system for monitoring and reporting an individual's carbon footprint, the system comprising:
an article of clothing including an embedded global positioning system (GPS) device, an accelerometer, and a transmission module, wherein the GPS device is configured to capture travel data for the individual, the accelerometer is configured to capture motion data for the individual, and the transmission module is configured to transmit the travel and motion data;
a data collection device connected with the transmission module, the data collection device configured to collect and store the transmitted travel and motion data; and
a server connected with the data collection device, the server configured to calculate the individual's carbon footprint based at least in part on the travel data and the motion data and generate a report of the individual's carbon footprint.

16. The system of claim 15, wherein the article of clothing is a pair of shoes which include insoles, and wherein the GPS device, the accelerometer, and the transmission medium are embedded into the insoles.

17. The system of claim 15, further comprising a personal computer coupled with the server and the data collection device, the personal computer configured to display the report.

18. A machine-readable medium for monitoring and reporting an entity's carbon footprint, the machine-readable medium having sets of instructions which, when executed by a machine, cause the machine to:
gather information about the entity, wherein the information includes utility information;
equip the entity with a global positioning system (GPS) device an accelerometer, and at least one pressure sensor;
gather utility usage data for the entity;
capture travel data for the entity;
calculate the entity's carbon footprint based at least in part on the utility usage data and the travel data; and
generate a report of the entity's carbon footprint.

19. The machine-readable medium of claim 18, wherein the set of instructions, when further executed by the machine, cause the machine to:
determine a first location at a first time of the entity based on the GPS device location information;
determine a second location at a second time of the entity based on the GPS device location information;
compare the first and second locations to determine a distance traveled; and
compare the first time and the second time to determine an amount of time for the entity to travel the distance.

20. The machine-readable medium of claim 19, wherein the set of instructions, when further executed by the machine, cause the machine to:
gather motion data of the entity from the accelerometer and the at least one pressure sensor for the distance traveled; and
compare the motion data against a motion data table, wherein the motion data table includes motion data readings for a plurality of activities.
